(19) United States
(12) Patent Application Publication
(10) Pub. No.: US 2003/0189980 A1
(43) Pub. Date: Oct. 9, 2003

(54) Method and apparatus for motion estimation between video frames

(75) Inventors: Ira Dvir, Tel Aviv (IL); Nitzan Rabinowitz, Ramat Hasharon (IL); Yoav Medan, Haifa (IL)

Correspondence Address: G.E. EHRLICH (1995) LTD., c/o ANTHONY CASTORINA, SUITE 207, 2001 JEFFERSON DAVIS HIGHWAY, ARLINGTON, VA, 22202, US

(73) Assignee: Moonlight Cordless Ltd.

(21) Appl. No.: 10/184,955

(22) Filed: Jul. 1, 2002

Related U.S. Application Data
(60) Provisional application No. 60/301,804, filed on Jul. 2, 2001.

(51) Int. Cl. H04N 7/12

(52) U.S. Cl. 375/240.16; 375/240.24

(57) ABSTRACT

Apparatus for determining motion in video frames, the apparatus comprising: a feature identifier for matching a feature in succeeding frames of a video sequence, a motion estimator for determining relative motion between said feature in a first one of said video frames and in a second one of said video frames, and a neighboring feature motion assignor, associated with said motion estimator, for assigning a motion estimation to further features neighboring said feature based on said determined relative motion.

### RELATIONSHIP TO EXISTING APPLICATIONS

The present application claims priority from U.S. Provisional Application No. 60/301,804 filed Jul. 2, 2001.

### FIELD OF THE INVENTION

The present invention relates to a method and apparatus for motion estimation between video frames.

### BACKGROUND OF THE INVENTION

Video compression is essential for many applications. Broadband Home and Multimedia Home Networking both require efficient transfer of digital video to computers, TV sets, set top boxes, data projectors and plasma displays. Both video storage media capacity and video distribution infrastructure call for low bit rate multimedia streams.

The enabling of Broadband Home and Multimedia Home Networking is very much dependent on high-quality narrow band multimedia streams. The growing demand for the transcoding of digital video from personal video cameras for a consumer's use, for example for editing on a PC etc. and the widespread transfer of video over ADSL, WLAN, LAN, Power Lines, HPNA and the like, calls for the design of cheap hardware and software encoders.

Most video compression encoders use inter and intra frame encoding based on an estimation of motion of image parts. There is thus a need for an efficient ME (Motion Estimation) algorithm, as motion estimation may comprise the most demanding computational task of tile encoders. Such an efficient ME algorithm may thus be expected to improve the efficiency and quality of the encoder. Such an algorithm may itself be implemented in hardware or software as desired and ideally should enable a higher quality of compression than is presently possible, whilst at the same time demanding substantially fewer computing resources. The computation complexity of such an ME algorithm is preferably reduced, and thus a new generation of cheaper encoders is preferably enabled.

Existing ME algorithms may be categorized as follows: Direct-Search, Logarithmic, Hierarchical Search, Three Step (TSS), Four Step (FSS), Gradient, Diamond-Search, Pyramidal search etc. each category having its variations. Such existing algorithms have difficulty in enabling the compression of high quality video to the bit-rate necessary for the implementation of such technologies as xDSL TV, IP TV, MPEG-2 VCD, DVR, PVR and real time full-frame encoding of MPEG-4, for example.

Any such improved ME algorithm may be applied to improve the compression results of existing CODECS like MPEG, MPEG-2 and MPEG-4, or any other encoder using motion estimation.

### SUMMARY OF THE INVENTION

According to a first aspect of the present invention there is provided apparatus for determining motion in video frames, the apparatus comprising:

a motion estimator for tracking a feature between a first one of the video frames and in a second one of the video frames, therefrom to determine a motion vector of the feature, and

a neighboring feature motion assignor, associated with the motion estimator, for applying the motion vector to other features neighboring the first feature and appearing to move with the first feature.

Preferably, the tracking of a feature comprises matching blocks of pixels of the first and the second frames.

Preferably, the motion estimator is operable to select initially a predetermined small groups of pixels in a first frame and to trace the groups of pixels in the second frame to determine motion therebetween, and wherein the neighboring feature motion assignor is operable, for each group of pixels, to identify neighboring groups of pixels that move therewith.

Preferably, the neighboring feature assignor is operable to use cellular automata based techniques to find the neighboring groups of pixels to identify, and assign motion vectors to these groups of pixels. Preferably, the apparatus marks all groups of pixels assigned a motion as paved, and repeats the motion estimation for unmarked groups of pixels by selecting further groups of pixels to trace and find neighbors therefor, the repetition being repeated up to a predetermined limit.

Preferably, the apparatus comprises a feature significance estimator, associated with the neighboring feature motion assignor, for estimating a significance level of the feature, thereby to control the neighboring feature motion assignor to apply the motion vector to the neighboring features only if the significance exceeds a predetermined threshold level.

Preferably the apparatus marks all groups of pixels in a frame assigned a motion as paved, the marking being repeated up to a predetermined limit according to a threshold level of matching, and repeats the motion estimation for unpaved groups of pixels by selecting further groups of pixels to trace and find unmarked neighbors therefor, the predetermined threshold level being kept or reduced for each repetition.

Preferably, the feature significance estimator comprises a match ratio determiner for determining a ratio between a best match of the feature in the succeeding frames and an average match level of the feature over a search window, thereby to exclude features indistinct from a background or neighborhood.

Preferably, the feature significance estimator comprises a numerical approximator for approximating a Hessian matrix of a misfit function at a location of the matching, thereby to determine the presence of a maximal distinctiveness.

Preferably, the feature significance estimator is connected prior to the feature identifier and comprises an edge detector for carrying out an edge detection transformation, the feature identifier being controllable by the feature significance estimator to restrict feature identification to features having relatively higher edge detection energy.

Preferably, the apparatus comprises a downsampler connected before the feature identifier for producing a reduction in video frame resolution by merging of pixels within the frames.

Preferably, the apparatus comprises a downsampler connected before the feature identifier for isolating a luminance signal and producing a luminance only video frame.

Preferably, the downsampler is further operable to reduce resolution in the luminance signal.

Preferably, the succeeding frames are successive frames, although they may be frames with constant or even non-constant gaps in between.

Motion estimation may be carried out for any of the digital video standards. The MPEG standards are particularly popular, especially MPEG 3 and 4. Typically, an MPEG sequence comprises different types of frames, I frames, B frames and P frames. A typical sequence may comprise an I frame, a B frame and a P frame. Motion estimation may be carried out between the I frame and the P frame and the apparatus may comprise an interpolator for providing an interpolation of the motion estimation to use as a motion estimation for the B frame.

Alternatively, the frames are in a sequence comprising at least an I frame, a first P frame and a second P frame, typically with intervening B frames. Preferably, motion estimation is carried out between the I frame and the first P frame and the apparatus further comprises an extrapolator for providing an extrapolation of the motion estimation to use as a motion estimation for the second P frame. As required, motion estimates may be provided for the intervening B frames in accordance with the previous paragraph.

Preferably, the frames are divided into blocks and the feature identifier is operable to make a systematic selection of blocks within the first frame to identify features therein.

Additionally or alternatively, the feature identifier is operable to make a random selection of blocks within the first frame to identify features therein.

Preferably, the motion estimator comprises a searcher for searching for the feature in the succeeding frame in a search window around the location of the feature in the first frame.

Preferably, the apparatus comprises a search window size presetter for presetting a size of the search window.

Preferably, the frames are divided into blocks and the searcher comprises a comparator for carrying out a comparison between a block containing the feature and blocks in the search window, thereby to identify the feature in the succeeding frame and to determine a motion vector of the feature between the first frame and the succeeding frame, for association with each of the blocks.

Preferably, the comparison is a semblance distance comparison.

Preferably, the apparatus comprises a DC corrector for subtracting average luminance values from each block prior to the comparison.

Preferably, the comparison comprises non-linear optimization.

Preferably, the non-linear optimization comprises the Nelder Mead Simplex technique.

Alternatively or additionally, the comparison comprises use of at least one of L1 and L2 norms.

Preferably, the apparatus comprises a feature significance estimator for determining whether the feature is a significant feature.

Preferably, the feature significance estimator comprises a match ratio determiner for determining a ratio between a closest match of the feature in the succeeding frames and an average match level of the feature over a search window, thereby to exclude features indistinct from a background or neighborhood.

Preferably, the feature significance estimator further comprises a thresholder for comparing the ratio against a predetermined threshold to determine whether the feature is a significant feature.

Preferably, the feature significance estimator comprises a numerical approximator for approximating a Hessian matrix of a misfit function at a location of the matching, thereby to locate a maximum distinctiveness.

Preferably, the feature significance estimator is connected prior to the feature identifier, the apparatus further comprising an edge detector for carrying out an edge detection transformation, the feature identifier being controllable by the feature significance estimator to restrict feature identification to regions of detection of relatively higher edge detection energy.

Preferably, the neighboring feature motion assignor is operable to apply the motion vector to each higher or full resolution block of the frame corresponding to a low resolution block for which the motion vector has been determined.

Preferably, the apparatus comprises a motion vector refiner operable to carry out feature matching on high resolution versions of the succeeding frames to refine the motion vector at each of the full or higher resolution blocks.

Preferably, the motion vector refiner is further operable to carry out additional feature matching operations on adjacent blocks of feature matched full or higher resolution blocks, thereby further to refine the corresponding motion vectors.

Preferably, the motion vector refiner is further operable to identify full or higher resolution blocks having a different motion vector assigned thereto from a previous feature matching operation originating from a different matched block, and to assign to any such full or higher resolution block an average of the previously assigned motion vector and a currently assigned motion vector.

Preferably, the motion vector refiner is further operable to identify full or higher resolution blocks having a different motion vector assigned thereto from a previous feature matching operation originating from a different matched block, and to assign to any such high resolution block a rule decided derivation of the previously assigned motion vector and a currently assigned motion vector.

Preferably, the apparatus comprises a block quantization level assigner for assigning to each high resolution block a quantization level in accordance with a respective motion vector of the block.

Preferably, the frames are arrangeable in blocks, the apparatus further comprising a subtractor connected in advance of the feature detector, the the subtractor comprising:

a pixel subtractor for pixelwise subtraction of luminance levels of corresponding pixels in the succeeding frames to give a pixel difference level for each pixel, and

a block subtractor for removing from motion estimation consideration any block having an overall pixel difference level below a predetermined threshold.

Preferably, the feature identifier is operable to search for features by examining the frame in blocks.

Preferably, the blocks are of a size in pixels according to at least one of the MPEG and JVT standard.

Preferably, the blocks are any one of a group of sizes comprising 8×8, 16×8, 8×16 and 16×16.

Preferably, the blocks are of a size in pixels lower than 8×8.

Preferably, the blocks are of size no larger than 7×6 pixels.

Alternatively or additionally, the blocks are of size no larger than 6×6 pixels.

Preferably, the motion estimator and the neighboring feature motion assigner are operable with a resolution level changer to search and assign on successively increasing resolutions of each frame.

Preferably, the successively increasing resolutions are respectively substantially at least some of a 1/64, 1/32, 1/16, eighth, a quarter, a half and full resolution.

According to a second aspect of the present invention there is provided apparatus for video motion estimation comprising:

a non-exhaustive search unit for carrying out a non exhaustive search between low resolution versions of a first video frame and a second video frame respectively, the non-exhaustive search being to find at least one feature persisting over the frames, and to determine a relative motion of the feature between the frames.

Preferably, the non-exhaustive search unit is further operable to repeat the searches at successively increasing resolution versions of the video frames.

Preferably, the apparatus comprises a neighbor feature identifier for identifying a neighbor feature of the persisting feature that appears to move with the persisting feature, and for applying the relative motion of the persisting feature to the neighbor feature.

Preferably, a feature motion quality estimator for comparing matches between the persisting feature in respective frames with an average of matches between the persisting feature in the first frame and points in a window in the second frame, thereby to provide a quantity expressing a goodness of the match to support a decision as to whether to use the feature and corresponding relative motion in the motion estimation or to reject the feature.

According to a third aspect of the present invention there is provided a video frame subtractor for preprocessing video frames arranged in blocks of pixels for motion estimation, the subtractor comprising:

a pixel subtractor for pixelwise subtraction of luminance levels of corresponding pixels in succeeding frames of a video sequence to give a pixel difference level for each pixel, and

a block subtractor for removing from motion estimation consideration any block having an overall pixel difference level below a predetermined threshold.

Preferably, the overall pixel difference level is a highest pixel difference value over the block.

Preferably, the overall pixel difference level is a summation of pixel difference levels over the block.

Preferably, the predetermined threshold is substantially zero.

Preferably, the predetermined threshold of the macroblocks is substantially a quantization level for motion estimation.

According to a fourth aspect of the present invention there is provided a post-motion estimation video quantizer for providing quantization levels to videoframes arranged in blocks, each block being associated with motion data, the quantizer comprising a quantization coefficient assigner for selecting, for each block, a quantization coefficient for setting a detail level within the block, the selection being dependent on the associated motion data.

According to a fifth aspect of the present invention there is provided a method for determining motion in video frames arranged into blocks, the method comprising:

matching a feature in succeeding frames of a video sequence,

determining relative motion between the feature in a first one of the video frames and in a second one of the video frames, and

applying the determined relative motion to blocks neighboring the block containing the feature that appear to move with the feature.

The method preferably comprises determining whether the feature is a significant feature.

Preferably, the determining whether the feature is a significant feature comprises determining a ratio between a closest match of the feature in the succeeding frames and an average match level of the feature over a search window.

The method preferably comprises comparing the ratio against a predetermined threshold, thereby to determine whether the feature is a significant feature.

The method preferably comprises approximating a Hessian matrix of a misfit function at a location of the matching, thereby to produce a level of distinctiveness.

The method preferably comprises carrying out an edge detection transformation, and restricting feature identification to blocks having higher edge detection energy.

The method preferably comprises producing a reduction in video frame resolution by merging blocks in the frames.

The method preferably comprises isolating a luminance signal, thereby to produce a luminance only video frame.

The method preferably comprises reducing resolution in the luminance signal.

Preferably, the succeeding frames are successive frames.

The method preferably comprises making a systematic selection of blocks within the first frame to identify features therein.

The method preferably comprises making a random selection of blocks within the first frame to identify features therein.

The method preferably comprises searching for the feature in blocks in the succeeding frame in a search window around the location of the feature in the first frame.

The method preferably comprises presetting a size of the search window.

The method preferably comprises carrying out a comparison between the block containing the feature and the blocks in the search window, thereby to identify the feature in the succeeding frame and determine a motion vector for the feature to be associated with the block.

Preferably, the comparison is a semblance distance comparison.

The method preferably comprises subtracting average luminance values from each block prior to the comparison.

The comparison preferably comprises non-linear optimization.

Preferably, the non-linear optimization comprises the Nelder Mead Simplex technique.

Alternatively or additionally, the comparison comprises use of at least one of a group comprising L1 and L2 norms.

The method preferably comprises determining whether the feature is a significant feature.

Preferably, the feature significance determination comprises determining a ratio between a closest match of tile feature in the succeeding frames and an average match level of the feature over a search window.

The method preferably comprises comparing the ratio against a predetermined threshold to determine whether the feature is a significant feature.

The method preferably comprises approximating a Hessian matrix of a misfit function at a location of the matching, thereby to produce a level of distinctiveness.

The method preferably comprises out an edge detection transformation, and restricting feature identification to regions of higher edge detection energy.

The method preferably comprises applying the motion vector to each high resolution block of the frame corresponding to a low resolution block for which the motion vector has been determined.

The method preferably comprises carrying out feature matching on high resolution versions of the succeeding frames to refine the motion vector at each of the high resolution blocks.

The method preferably comprises carrying out additional feature matching operations on adjacent blocks of feature matched high resolution blocks, thereby further to refine the corresponding motion vectors.

The method preferably comprises identifying high resolution blocks having a different motion vector assigned thereto from a previous feature matching operation originating from a different matched block, and assigning to any such high resolution block an average of the previously assigned motion vector and a currently assigned motion vector.

The method preferably comprises identifying high resolution blocks having a different motion vector assigned thereto from a previous feature matching operation originating from a different matched block, and assigning to any such high resolution block a rule decided derivation of the previously assigned motion vector and a currently assigned motion vector.

The method preferably comprises assigning to each high resolution block a quantization level in accordance with a respective motion vector of the block.

The method preferably comprises:

pixelwise subtraction of luminance levels of corresponding pixels in the succeeding frames to give a pixel difference level for each pixel, and

removing from motion estimation consideration any block having an overall pixel difference level below a predetermined threshold.

According to a further aspect of the present invention there is provided a video frame subtraction method for preprocessing video frames arranged in blocks of pixels for motion estimation, the method comprising:

pixelwise subtraction of luminance levels of corresponding pixels in succeeding frames of a video sequence to give a pixel difference level for each pixel, and

removing from motion estimation consideration any block having in overall pixel difference level below a predetermined threshold.

Preferably, the overall pixel difference level is a highest pixel difference value over the block.

Preferably, the overall pixel difference level is a summation of pixel difference levels over the block.

Preferably, the predetermined threshold is substantially zero.

Preferably, the predetermined threshold of the macroblocks is substantially a quantization level for motion estimation.

According to a further aspect of the present invention there is provided a post-motion estimation video quantization method for providing quantization levels to videoframes arranged in blocks, each block being associated with motion data, the method comprising selecting, for each block, a quantization coefficient for setting a detail level within the block, the selection being dependent on the associated motion data.

### BRIEF DESCRIPTION OF THE DRAWINGS

For a better understanding of the invention, and to show how the same may be carried into effect, reference will now be made, purely by way of example, to the accompanying drawings, in which:

FIG. 1 is a simplified block diagram of a device for obtaining motion vectors of blocks in video frames according to a first embodiment of the present invention,

FIG. 2 is a simplified block diagram showing in greater detail the distinctive match searcher of FIG. 1,

FIG. 3 is a simplified block diagram showing in greater detail a part of the neighboring block motion assigner and searcher of FIG. 1,

FIG. 4 is a simplified block diagram showing a preprocessor for use with the apparatus of FIG. 1,

FIG. 5 is a simplified block diagram showing a post processor for use with the apparatus of FIG. 1,

FIG. 6 is a simplified diagram showing succeeding frames in a video sequence,

FIGS. 7-9 are schematic drawings showing search strategies for blocks in video frames,

FIG. 10 shows the macroblocks in a high definition video frame originating from a single super macroblock in a low resolution video frame,

FIG. 11 shows assignment of motion vector values to macroblocks,

FIG. 12 shows a pivot macroblock and neighboring macroblocks,

FIGS. 13 and 14 illustrate the assignment of motion vectors in the event of a macroblock having two neighboring pivot macroblocks, and

FIGS. 15 to 21 are three sets of video frames, each set respectively showing a video frame, a video frame to which motion vectors have been applied using the prior art and a video frame to which motion vectors have been applied using the present invention.

### DESCRIPTION OF THE PREFERRED EMBODIMENTS

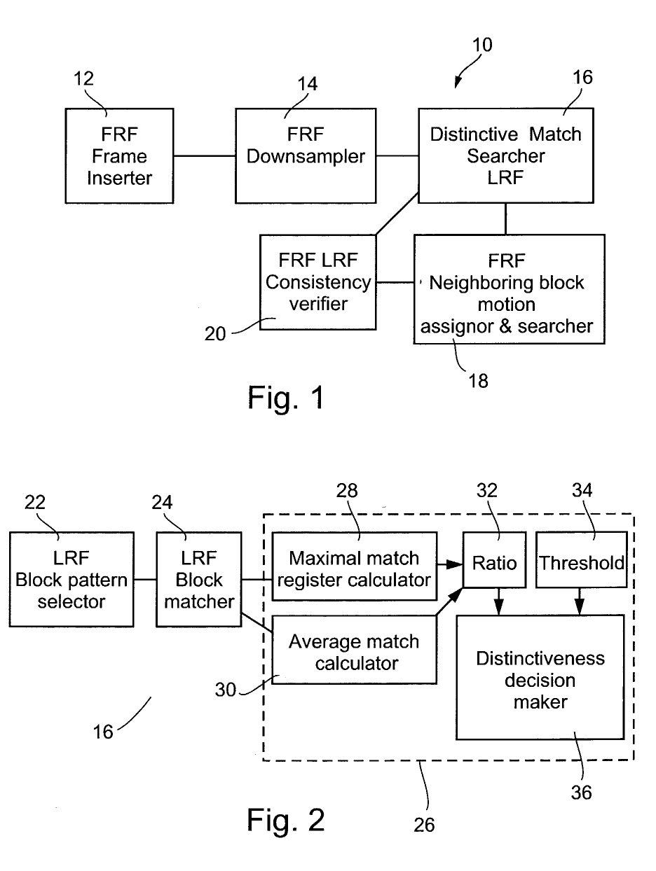

Reference is now made to FIG. 1, which is a generalized block diagram showing apparatus for determining motion in video frames according to a first preferred embodiment of the present invention. In FIG. 1, apparatus 10 comprises a frame inserter 12 for taking successive full resolution frames of a current video sequence and inserting them into the apparatus. A downsampler 14 is connected downstream of the frame inserter and produces a reduced resolution version of each video frame. The reduced resolution version of the video frame may typically be produced by isolating the luminance part of the video signal and then performing averaging.

Using the downsampler, motion estimation is preferably performed on a gray scale image, although it may alternatively be performed on a full color bitmap.

Motion estimation is preferably done with 8×8 or 16×16 pixel macroblocks, although the skilled man will appreciate that any appropriate size block may be selected for given circumstances. In a particularly preferred embodiment, macroblocks smaller than 8×8 are used to give greater particularity and in particular, preference is given to macroblock sizes that are not powers of two, such as a 6×6 or a 6×7 macroblock.

The downsampled frames are then analyzed by a distinctive match searcher 16 which is connected downstream of the downsampler 14. The distinctive match searcher preferably selects features or blocks of the downsampled frame and proceeds to find matches thereto in a succeeding frame. If a match is found then the distinctive match searcher preferably determines whether the match is a significant match or not. Operation of the distinctive match searcher will be discussed below in greater detail with respect to FIG. 2. It is noted that searching for a significance level in the match is costly in terms of computing load and is only necessary for higher quality images, for example broadcast quality. The search for significance of the match, or distinctiveness, may thus be omitted when high quality is not required.

Downstream of the distinctive match searcher is a neighboring block motion assignor and searcher 18. The neighboring block motion assignor assigns a motion vector to each of the neighboring blocks of the distinctive feature, the vector being the motion vector describing the relative motion of the distinctive feature. The assignor and searcher 18 then carries out feature searching and matching to validate the assigned vector, as will be explained in more detail below. The underlying assumption behind the use of the neighboring block motion assignor 18 is that if a feature in a video frame moves then in general, except at borders between different objects, its neighboring features move together with it.

Reference is now made to FIG. 2, which shows in greater detail the distinctive match searcher 16. The distinctive match searcher preferably operates using the low resolution frame. The distinctive match searcher comprises a block pattern selector 22 which selects a search pattern with which to select blocks for matching between successive frames. Possible search patterns include regular and random search patterns and will be discussed in greater detail later on.

The selected blocks from the earlier frame are then searched for by carrying out attempted matches over the later frame using a block matcher 24. Matching is carried out using any one of a number of possible strategies as will be discussed in more detail below, and block matching may be carried out against nearby blocks or against a window of blocks or against all of the blocks in the later frame, depending on the amount of movement expected.

A preferred matching method is semblance matching, or semblance distance comparison. The equation for the comparison is given below.

The comparison between blocks in the present, or any other stage of the matching process, may additionally or alternatively utilize non-linear optimization. Such non-linear optimization may comprise the Nelder Mead Simplex technique.

In an alternative embodiment, the comparison may comprise use of L1 and L2 norms, the L1 norm being referred to hereinafter as sum of difference (SAD).

It is possible to use windowing to limit the scope of a search. In the event of use of windowing at any one of the searches, the window size may be preset using a window size presetter.

The result of matching is thus a series of matching scores. The series of scores are inserted into a feature significance estimator 26, which preferably comprises a maximal match register 28 which stores the highest match score. An average match calculator 30 stores an average or mean of all of the matches associated with the current block and a ratio register 32 computes a ratio between the maximal match and the average. The ratio is compared with a predetermined threshold, preferably held in a threshold register 34, and any feature whose ratio is greater than the threshold is determined to be distinctive by a distinctiveness decision maker 36, which may be a simple comparator. Thus, significance is not determined by the quality of an individual match but by the relative quality of the match. Thus the problem found in prior art systems of erroneous matches being made between similar blocks, for example in a large patch of sky, is significantly reduced.

If the current feature is determined to be a significant feature then it is used, by the neighboring block motion assigner and searcher 18, to assign the motion vector of the feature as a first order motion estimate to each neighboring feature or block.

In one embodiment, feature significance estimation is calculated using a numerical approximator for approximating a Hessian matrix of a misfit function at a location of a match. The Hessian matrix is the two dimensional equivalent of finding a turning point in a graph and is able to distinguish a maximum in the distinctiveness from a mere saddle point.

In another embodiment, the feature significance estimator is connected prior to said feature identifier and comprises an edge detector, which carries out an edge detection transformation. The feature identifier is controllable by the feature significance estimator to restrict feature identification to features having higher edge detection energy.

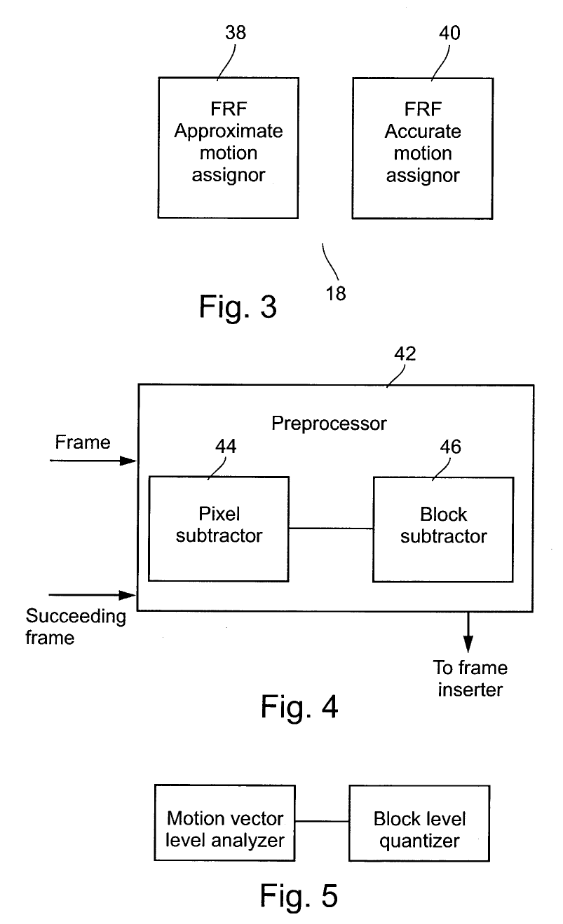

Reference is now made to FIG. 3 which shows the neighboring block motion assigner and searcher 18 in greater detail. As shown in FIG. 3, the assigner and searcher 18 comprises an approximate motion assignor 38 which simply assigns the motion vector of a neighboring significant feature, and an accurate motion assignor 40 which uses the assigned motion vector as a basis for carrying out a matching search to carry out an accurate match in the neighborhood suggested by the approximate match. The assigner and searcher preferably operates on the full resolution frame.

In the event that there are two neighboring significant features, the accurate motion assigner may use an average of the two motion vectors or may use a predetermined rule to decide what vector to assign to the current feature.

In general, succeeding frames between which matches are carried out, are directly successive or sequential frames. However there may be occasions when jumps are made between frames. In particular, in a preferred embodiment, matches are made between a first frame, typically an I frame, and a later following frame, typically a P frame, and an interpolation of the movement found between the two frames is applied to intermediate frames, typically B frames. In another embodiment, matching is carried out between an I frame and a following P frame and extrapolation is then applied to a next following P frame.

Prior to carrying out searching it is possible to carry out DC correction of the frame, which is to say that an average luminance level of the frame or of an individual block may be calculated and then subtracted.

Reference is now made to FIG. 4, which is a simplified diagram of a preprocessor 42 for carrying out preprocessing of frames prior to motion estimation. The preprocessor comprises a pixel subtractor 44 for carrying out subtraction of corresponding pixels between succeeding frames. The pixel subtractor 44 is followed by a block subtractor 46 which removes from consideration blocks which, as a result of the pixel subtraction, yield a pixel difference level that is below a predetermined threshold.

Pixel subtraction may generally be expected to yield low pixel difference levels in cases in which there is no motion, which is to say that the corresponding pixels in the succeeding frames are the same. Such preprocessing may be expected to reduce considerably the amount of processing in the motion detection stage and in particular the extent of detection of spurious motion.

Quantized subtraction allows tailoring of quantized skipping of matching parts of the frame (preferably in the shape of macroblocks) according to the desired bit-rate of the output stream.

The quantized subtraction scheme allows the skipping of the motion estimation process for unchanged macroblocks, which is to say macroblocks that appear stationary between the two frames being compared. By default the full resolution frames are transformed to gray scale (the luminance part of the YVU picture), as described above. Then the frames are subtracted, pixelwise, from one another. All macroblocks for which all pixel-differences result in zero (64 pixels for a 8×8 MB and 256 pixels for a 16×16 MB) may be regarded as unchanged and marked as macroblocks to be skipped before entering the process of motion estimation. Thus a full frame search for matching macroblocks may be avoided.

It is possible to threshold the subtraction by adjusting the unchanged-macroblock tolerance value to the quantization-level of the macroblocks which do go through the motion estimation process. The encoder may set the threshold of the quantized subtraction scheme according to the quantization level of the blocks which have been through the motion estimation process. The higher the level of quantization during the motion estimation, the higher will be the tolerance level associated with the subtracted pixels, and the higher will be the number of skipped macroblocks.

By setting the subtraction block threshold to a higher value, more macroblocks are skipped in the motion identification process, thereby freeing capacity for other encoding needs.

In the above described embodiment, a first pass over at least some of the blocks is required in order to obtain a threshold. Preferably a double-pass encoder allows a threshold adjustment to be done for each frame according to the encoding results of a first pass. However, in another preferred embodiment the quantized subtraction scheme may be implemented in a single pass encoder, adjusting the quantization for each frame according to the previous frame.

Reference is now made to FIG. 5 which is a simplified block diagram showing a motion detection post processor 48 according to a preferred embodiment of the present invention. The post processor 48 comprises a motion vector amplitude level analyzer 50 for analyzing the amplitude of an assigned motion vector. The amplitude analyzer 50 is followed by a block quantizer 52 for assigning a block quantization level in inverse proportion to the vector amplitude. The block quantization level may then be used in setting the level of detail for encoding pixels within that block on the basis that the human eye picks up fewer details the faster a feature is moving.

Considering the procedure in greater detail, an embodiment is described for the MPEG-2 digital video standard. The skilled person will appreciate that the example may be extended to MPEG 4 and other standards and, more generally the algorithm may be implemented in any inter and intra frame encoder.

As referred to above, a certain level of coherency is present in frame sequences of motion pictures, which is to say that features move or change smoothly. It is thus possible to locate a distinctive part of a picture in two successive (or remotely succeeding) frames and find the motion vectors of this distinctive part. That is to say it is possible to determine the relative displacement of distinctive fragments of frames A and B and it is then possible to use those motion vectors to assist in finding all or some of regions adjacent to the distinctive fragments.

Distinctive portions of the frames are portions that contain distinctive patterns, which may be recognized and differentiated from their surrounding objects and background, with a reasonable level of certainty.

Simply put, it may be said that if the nose of a face in Frame A has moved to a new location in Frame B, it is reasonable to assume that the eyes of the very same face have also moved with the nose.

The identification of distinctive parts of the frame, together with a confined search of the neighboring parts, minimizes dramatically the error rate as compared to conventional frame part matching. Such errors usually degrade the picture quality, add artifacts and cause what is known as blocking, the impression that a single feature is behaving as separate independent blocks.

As a first step towards the search for distinctive parts of the picture, the luminance (gray scale) frame is downsampled (to ½-1/32 or any other downsample level of its original size), as described above. The level of downsampling may be regarded as a system variable for setting by a user. For example a 1/16 downsample of 180×144 pixels may represent a 720×576 pixels frame and 180×120 pixels may represent a 720×480 pixels frame, and so on.

It is possible to execute the search on the full resolution frame, but it is inefficient. The downsampling is done in order to ease the detection of distinctive portions of the frame, and minimize the computational burden.

In a particularly preferred embodiment, the initial search is carried out following downsampling by 8. That is followed by a refined search at a downsampling of 4, followed by a refined search at a downsampling of 2 followed by final processing on the full resolution frame.

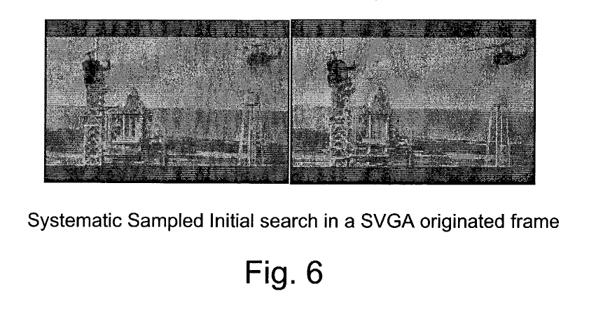

Reference is now made to FIG. 6, which shows two succeeding frames. During the motion estimation process the distinctive parts of the picture, following downsampling and subtraction, may be identified in successive, or remotely succeeding, frames and a motion vector calculated therebetween.

To enable systematic search and detection of distinctive parts of the frame, the whole downsampled frame is divided into units referred to herein as super-macroblocks. In the present example the super-macroblocks are blocks of 8×8 pixels, but the skilled person will appreciate the possibility of using other sized and shaped blocks. Downsampling of a PAL (720×576) frame, for example, may result in 23 (22.5) super-macroblocks in a slice or row, and 18 super-macroblocks in a column. Hereinbelow, the above downsampled frame will be referred to as the Low Resolution Frame or (LRF).

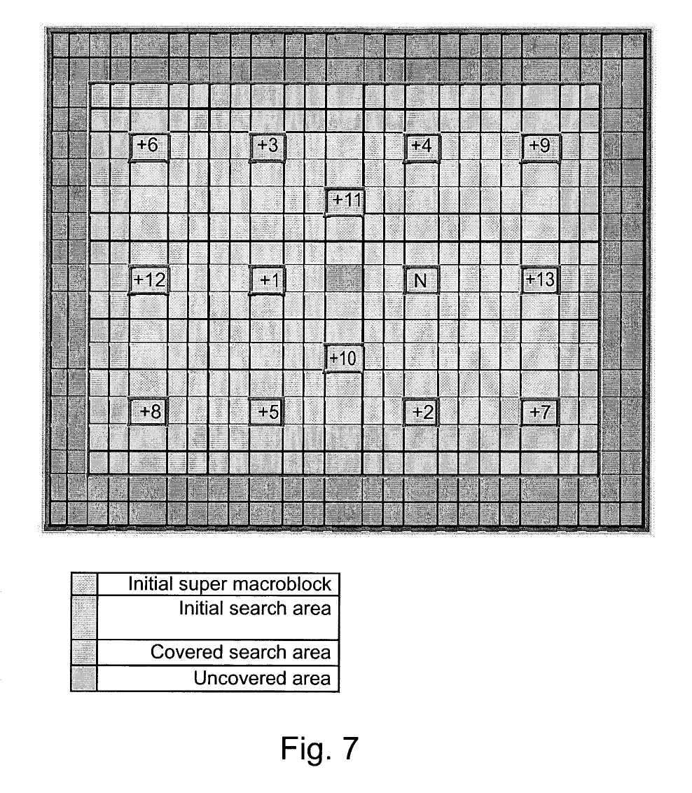

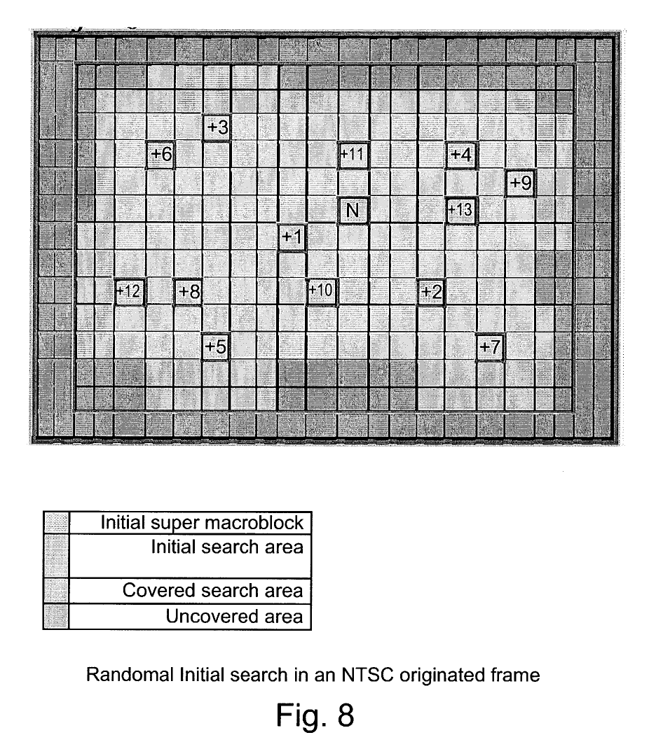

Reference is now made to FIGS. 7 and 8, which are schematic diagrams showing search schemes for finding matching super macroblocks in the succeeding frames.

FIG. 7 is a schematic diagram showing a systematic search for matches of all or sample super-macroblocks, in which super-macroblocks are selected systematically across the first frame and searched for in the second frame. FIG. 8 is a schematic diagram showing a random selection of super-macroblocks for searching. It will be appreciated that numerous variations of the above two types of search may be carried out. In FIGS. 7 and 8 there are 14 super-macroblocks, but it will of course be appreciated that the number of the super-macroblocks may vary from a few super-macroblocks to the full number of the super-macroblocks of the frame. In the latter case the figures demonstrate respectively an initial search of a 25×19 super-macroblocks frame, and a 23×15 frame.

In FIGS. 7 and 8, each super-macroblock is 8×8 pixels in size, representing 4 full resolution 16×16 pixels adjacent macroblocks according to the MPEG-2 standard, forming a square of 32×32 pixels. These numbers may vary according to any specific embodiment.

A search area of ±16 pixels in low resolution is equivalent to a full resolution search of ±64 range, in addition to the 32 pixels represented by the super-macroblock itself. As discussed above, it is possible to enlarge the search window to various sizes representing even smaller window than ±16 and as large as the full frame.

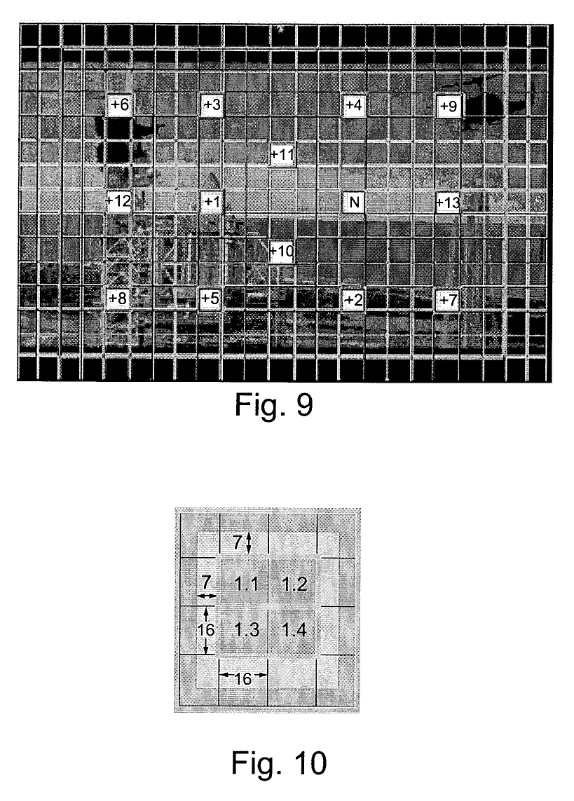

Reference is now made to FIG. 9, which is a simplified frame drawing illustrating, using a high resolution picture, the coverage of the systematic initial search with just 14 super-macroblock.

In the following, a more detailed description is given of a preferred search procedure according to one embodiment of the present invention. The search procedure is described in a succession of stages.

Stage 0: Search Management

A state database (map) of all macroblocks (16×16 full resolution frame) is kept. Each cell in the state database corresponds to a different macroblock (coordinate i, j) and contains 3 motion estimation attributes a follows, one macroblock state (−1,0,1) and three motion vectors (AMV1 x, y; AMV2 x, y; MV x, y). The macroblock state attribute is a state flag that is set and changed during the course of the search to indicate the status of the respective block. The motion vectors are divided into attributed motion vectors assigned from neighboring blocks and final result vectors.

Initially, all macroblocks' state are marked as −1 (not matched). Whenever a macroblock is matched (see Stage d and e, below) its state is changed to 0 (matched).

Whenever all the four adjacent macroblocks of a matched macroblock, see Stage d, e and f below, have been searched for matches, regardless of the results of the search, the macroblock's state is changed to 1, to mean that processing has been completed for the respective macroblock.

Whenever a distinctive super-macroblock is matched, see stage b below, the AMV1 (approximate motion vectors 1) of neighboring macroblock 1.n (as depicted in FIG. 5) are marked, that is to say the motion vector determined for the distinctive macroblock is assigned as an approximate match to each of its neighbors.

Whenever a 1.n, or neighboring, macroblock is matched, see stage d below, its MV is marked, and now its MV is used to mark the AMV1 of all of its adjacent or neighboring macroblocks.

In many cases, a particular macroblock may be assigned different approximate motion vectors from different neighboring macroblocks. Thus, whenever the MVs of a matched adjacent macroblock differ from the AMV1 values already assigned to the macroblock in question by another one of its adjacent macroblocks, then a threshold is used to determine whether the two motion vectors are compatible. Typically if distance d≦4 (for both x and y values), then the average between the two is taken as a new AMV1.

On the other hand, if the threshold is exceeded, then it is presumed that the motions are not compatible. The macroblock in question is apparently on the boundary of a feature. Thus, whenever the MVs of a matched macroblock differ from the AMV1 values already given to an adjacent macroblock, by another adjacent macroblock, by d>4 (for x or y values), then the value of the second adjacent macroblock is retained as AMV2.

Stage a: Searching for Matching Super-Macroblocks

In the search scheme in the LRF (low resolution frame), in order to matchsuper-macroblocks in two frames, a function known as a misfit function is used. Useful misfit functions may for example be based on either the standard L1 and L2 norms, or may use a more sophisticated norm based on the Semblance metric defined as follows:

For any two N-vectors cₖ₁ and cₖ₂ a Semblance distance (SEM) between them has the following expression:

$$SEM = \frac{{\sum }_{m = 1}^{N} ( {\sum }_{n = 1}^{2} {c}_{mn}^{2} )}{{\sum }_{m - 1}^{N} {( {\sum }_{n - 1}^{2} {c}_{mn} )}^{2}}$$

In a further preferred embodiment, one may choose a more sophisticated Semblance based norm by simply DC-correcting the two vectors, that is to say replacing the two vectors with new vectors formed by subtracting an average value from each component.

With or without DC correction, the choice of the semblance metric is regarded as advantageous in that it makes the search substantially more robust to the presence of outlying values.

Using the above-defined Semblance misfit function, a direct search may be executed to obtain a match to a single initial super-macroblock, in the low-resolution frame. Alternatively, such a search can be carried out by any effective nonlinear optimization technique, from which the nonlinear SIMPLEX method—known in the art as the Nelder-Mead Simplex method, yields good results.

The search for a match to the nth super-macroblock in the first frame preferably starts with the nth super-macroblock in the second frame, in the range of ±16 pixels. In case of failure to find a match, or, to identify the super-macroblock as a distinctive block, as will be described in Stage b below, the search is repeated, starting frown the n+1 super-macroblock of the last failed search.

Stage b: Declaring a Matched Super-Macroblock as Distinctive

If a match of a super-macroblock is found, then the ratio between

a: the match of the current super-macroblock to its best identical block match (8×8 pixels), and

b: the match of the macroblock to the average match of the rest of its full searched region (40×40 excluding the 8×8 matched area), is examined. If the ratio between a and b is higher than a certain threshold, then the present macroblock is regarded as a distinctive macroblock. Such a double stage procedure helps to ensure that distinctive matching is not erroneously found in regions where neighboring blocks are similar but in fact no movement is actually occurring.

An alternative approach to find a distinctive macroblock is by numerically approximating the Hessian matrix of the misfit function, which is the square matrix of the second partial derivative of the misfit function. Evaluating the Hessian at the determined macroblock match coordinate, gives an indication as to whether the present location represents the two dimensional equivalent of a turning point. The presence of a maximum together with a reasonable level of absolute distinctiveness indicates that the match is a useful match.

A further alternative embodiment to finding distinctiveness applies an edge-detection transformation, for example using a Laplacian filter, Sobel filter or Roberts filter to the two frames, and then limits the search to those areas in the “subtracted frame” for which the filter output energy is significantly high.

Stage c: Setting Rough MVs of a Distinctive Super-Macroblock

When a distinctive super-macroblock has been identified, then its determined motion vector is assigned to the corresponding four macroblocks of the full resolution frame.

The distinc [symbol] super-macroblock's number has been set [symbol] in the initial search. The associated motion vector setting serves as an approximate temporal motion vector to carry out searching of the high resolution version of the next frame, as will be discussed below.

Stage d: Setting Accurate MVs of a Single Full-Res Macroblock

Reference is now made to FIG. 10, which is a simplified diagram showing the layout of the four macroblocks in the high resolution frame that correspond to a single supermacroblocks in the low resolution frame. Pixel sizes are indicated.

To obtain the accurate motion vectors of any one of the 4 macroblocks of the initial super-macroblock, the full resolution frame is searched for a single one of the four macroblocks in its original 16×16 pixels size. The search begins with macroblock number 1.1 within the range of ±7 pixels.

If a match for macroblock number 1.1 is not found, the same procedure is preferably repeated with macroblock number 1.2, again within the original 16×16 pixels originating in the same 8×8 super-macroblock. If block 1.2 cannot be matched then the same procedure is repeated with block 1.3, and then with block 1.4.

If all four macroblocks as depicted in FIG. 10 can not be found, the procedure skips back to a new block and Stage a.

Stage e: Updating the Motion Vectors for Adjacent Macroblocks

If a match of one of the four macroblocks is found, the state of the macroblock in the search database is changed to 0 (“matched”).

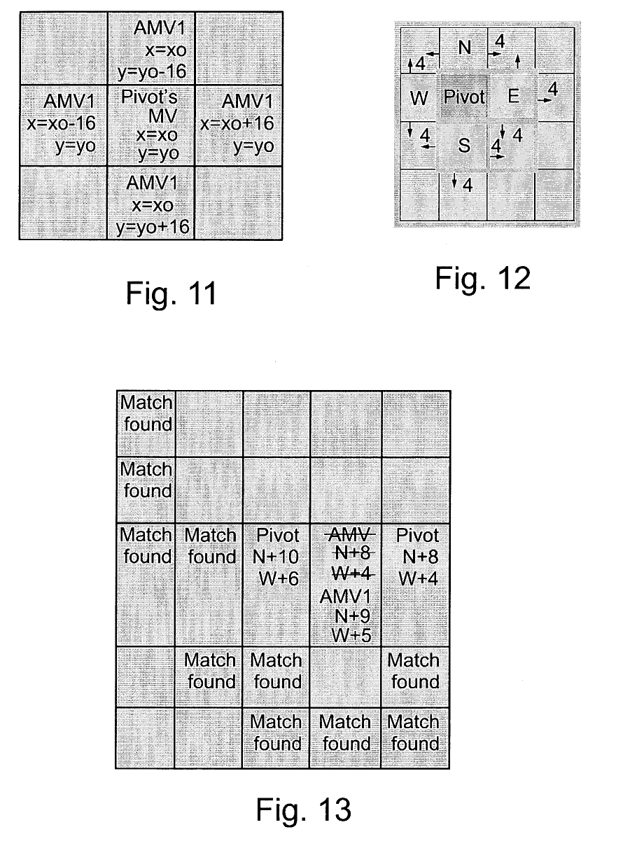

The MV of the matched macroblock is marked in the State Database. The matched macroblock now preferably serves as what is hereinbelow referred to as a pivot macroblock. The motion vector of the pivot macroblock is now assigned as the AMV1 or a search starting point to each of its adjacent or neighboring macroblocks. The AMV1 for the adjacent macroblocks is marked in the State Database, as depicted in attached FIG. 11.

Reference is now made to FIG. 12, which is a simplified diagram showing an arrangement of macroblocks around a pivot macroblock. As shown in the figure, adjacent or neighboring macroblocks for the purposes of the present embodiment are those macroblocks that border the Pivot macroblock on the North, South, East and West sides.

Stage f: Search for Matches to the Pivot's Adjacent Macroblocks

The macroblocks in the region under consideration now having approximate motion vectors, a confined search of ±4 pixels range is preferably used for precise matching. Indeed, as illustrated in FIG. 12, preferably, matches to North, South, East and West only are looked for at the present stage. Any kind of known search (like DS etc.) may be implemented for the purposes of the confined search.

When the above confined searches are finished, the state of the respective Pivot macroblock is changed to 1.

Stage g: Setting of New Pivot Macroblocks

The state of each adjacent macroblock that was matched is changed to 0 to indicate having been matched. Each matched macroblock may now serve in turn as a pivot, to permit setting of the AMV1 values of its neighboring or adjacent macroblocks.

Stage h: Updating MVs

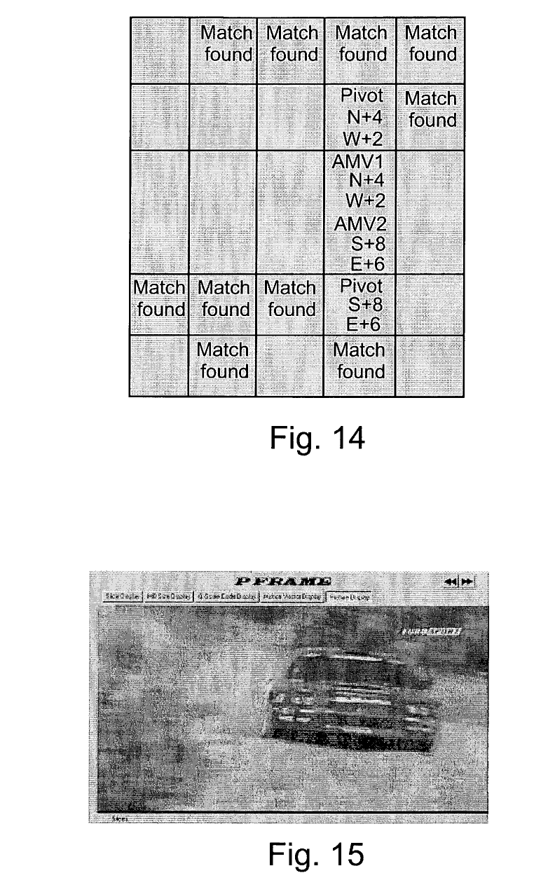

The AMV1 of the adjacent macroblocks are thus set according to the motion vectors of each Pivot macroblock. Now in some cases, as has already been outlined above, one or more of the adjacent macroblocks may already have an AMV1 value, typically due to having more than one adjacent pivot. In such a case the following procedure, described with reference to FIGS. 13 and 14, is used:

If the present AMV1 values differ from the MV values of the newly matched adjacent Pivot macroblock by d≦4 (for both x and y values), the average value is kept as AMV1.

On the other hand, if the threshold distance d=4 is exceeded, then the value of the later of the pivots is retained.

Stage I. Stopping Situation:

When all Pivot macroblocks have been marked as 1, meaning that they are completed with, a stopping situation occurs. At this point an initial search is repeated starting with the n+1 8×8 numbered super-macroblock of the initial search area.

Updating the Initial Search Super-Macroblocks Numbers

Whenever an additional distinctive super-macroblock is found, it is numbered as n+1 from the last distinctive super-macroblock that has been found. The numbering ensures that distinctive macroblocks are searched for in the order in which they were found, skipping the super-macroblocks that have not been found to be distinctive.

Stage i:

When there are no neighbors left to search, and no super-macroblocks are left, further searching is ended. Optionally any ordinary search known in the art, for example DS or 3SS or 4SS or HS or Diamond is used for any remaining macroblocks.

If no further search is conducted, all macroblocks for which no matches were found, are preferably arithmetically encoded.

Initial searching through the pixels may be carried out on all pixels. Alternatively it may be carried only on alternate pixels or it may be carried out using other pixel skipping processes.

Quantized Quantization Scheme:

In a particularly preferred embodiment of the present invention a post-processing stage is carried out. An intelligent quantization-level setting is applied to the macroblocks, according to their respective extents or magnitudes of motion. Since the motion estimation algorithm, as described above, keeps a state database of the matches of the macroblocks and detects displaced macroblocks in feature-orientated groups, the identification of global motion within the group can be used to allow manipulation of the rate control as a function of the motion magnitude, thereby to take advantage of limitations of the human eye, for example by supplying lower levels of detail for faster moving feature orientated groups.

Unlike the DS motion estimation algorithm, and for that matter other motion estimation algorithms, which tend to match many random macroblocks, the present embodiments are accurate enough to enable the correlation of the quantization to the level of the motion. By matching higher quantization coefficients to macroblocks with higher motion—macroblocks in which some of the detail is likely to escape the human eye anyway—the encoder may free bytes for macroblocks with lesser motion or for improvements in quality in the I frames. By doing so the encoder may thus allow, at the same bit-rate as a conventional encoder using equal quantization, a different quantization for different parts of the frame according to the level of their perception by the human eye, resulting in a higher perceived level of image quality.

The quantization scheme preferably works in two stages as follows:

Stage a:

In the state database of the motion estimation algorithm, as described above, a record is kept of each macroblock which has been successfully matched and which has at least two neighbors that have been matched. A macroblock that has been successfully matched in this way is referred to as a pivot. Hereinbelow, such a group of macroblocks is referred to as a single paving group, and the process of matching between neighbours associated with the pivots in succeeding frames is referred to as paving.

Stage b:

Whenever a single paving process reaches the stage that there are no neighbors left to search, the motion vectors of the group of macroblock that was matched are calculated. If the average motion vectors of all the macroblocks in the group are above a certain threshold, the quantization coefficients of the macroblocks are set to A+N, where A is the average coefficient applied over the entire frame. If the average motion vectors of the group are below that threshold, the quantization coefficients of the macroblocks are set to A−N.

The value of the threshold may then be set according to bit-rate. It is also possible to set the threshold value according to the difference between the average motion vectors, of the group of macroblocks that are matched in a single paving group, to the average motion vectors of the full frame.

The present embodiments thus include a quantized subtraction scheme for motion-estimation skipping; an algorithm for motion estimation; and a scheme for quantization of motion estimated portions of a frame according to their level of motion.

Two principle ideas underlie the above-described embodiments. The first is the concept of exploiting the coherency property of motion pictures. The second is that a misfit of macroblocks below a prescribed threshold is a meaningful guide for the continuation of the full picture search.

All currently reported motion estimation (ME) algorithms employ a one-at-a time macroblock search that uses a variety of optimization techniques. By contrast the present embodiments are based on a procedure which identifies global motion between frames of video streams. That is to say it uses the concept of neighboring blocks to deal with the organic, in motion features of the picture. The frames that are being analyzed for motion may be successive frames or frames that are distant from one another in a video sequence, as discussed above.

The procedure used in the above described embodiments preferably finds motion vectors (MVs) for distinctive parts (preferably in the shape of macroblocks) of the frames, which are taken to describe the feature based or global motion at that region in the frame. The procedure simultaneously updates the MVs of the predicted neighboring parts of the frame, according to the global motion vectors. Once all the matching neighboring parts of the frames (adjacent macroblocks) are paved, the algorithm identifies another distinctive motion of another part of the frame. Then the paving process is repeated, until no other distinctive motion can be identified.

The above-described procedure is efficient, in that it provides a way of avoiding the exhausting brute-force search which is widely used in the current art.

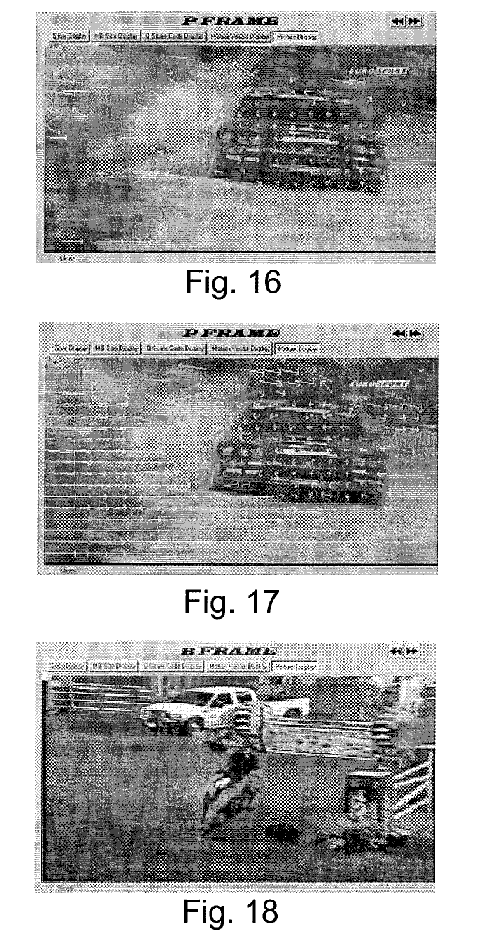

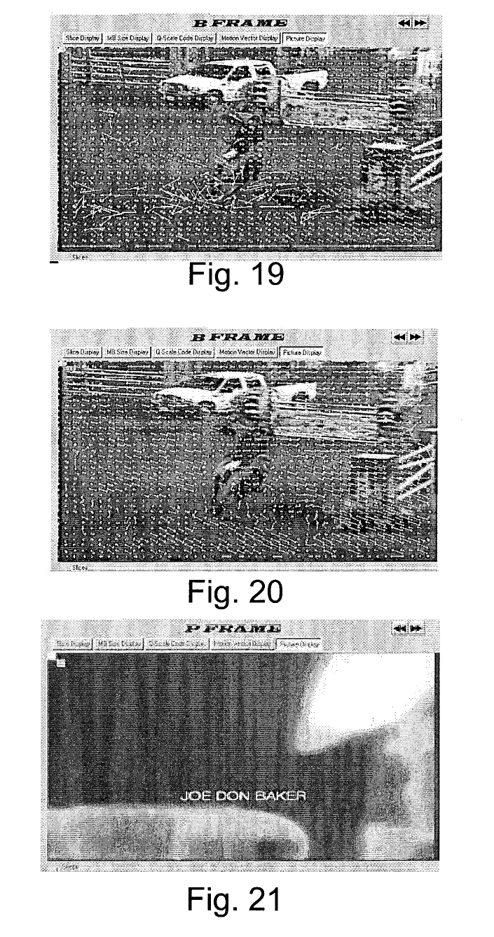

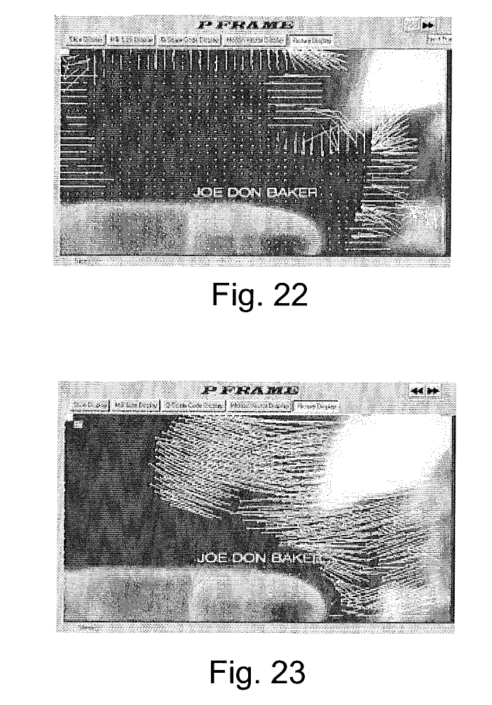

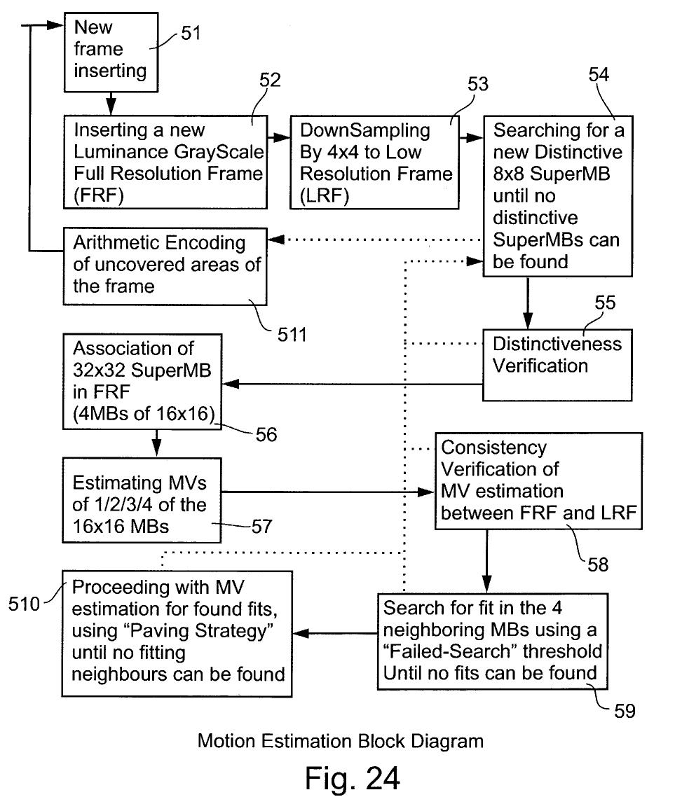

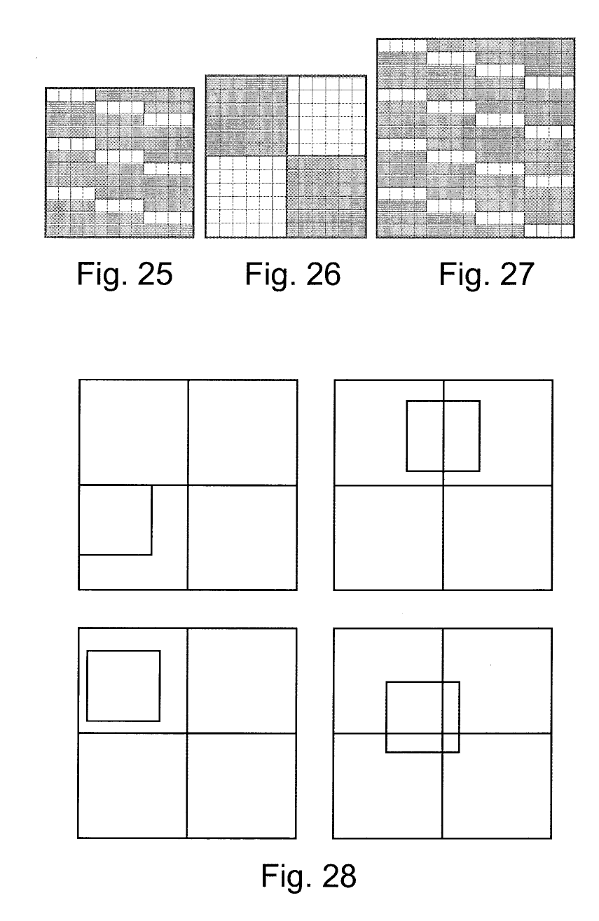

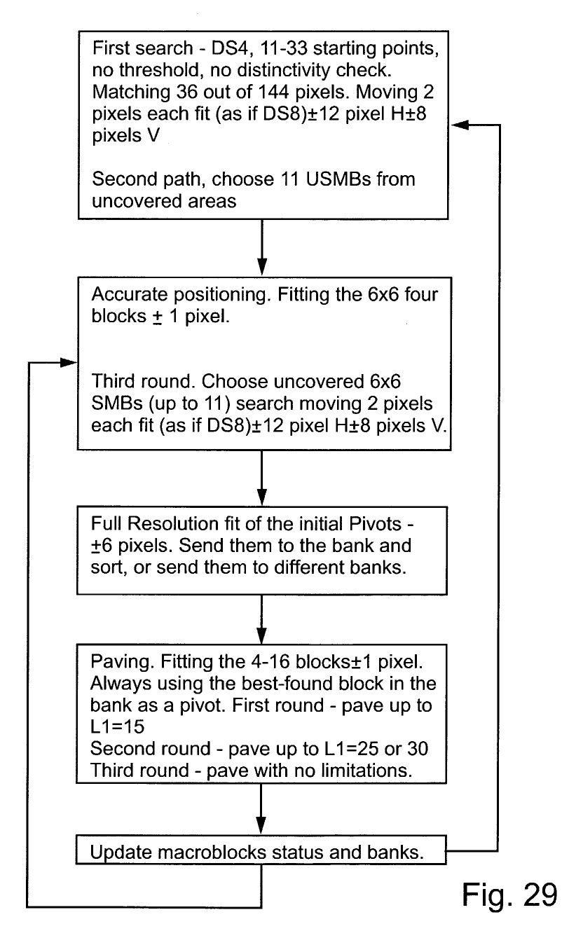

The effectiveness of the present embodiments is illustrated by three sets of figures, FIGS. 15-17, 18-20 and 21-23. In each set a first figure shows a video frame, a second figure shows the video frame with motion vectors provided by representative prior art schemes and the third figure shows motion vectors provided according to embodiments of the present invention. It will be noted that in the prior art, large numbers of spurious motion vectors are applied to background areas where matches between similar blocks have been mistaken for motion.

As mentioned above, a preferred embodiments includes a preprocessing stage, involving a quantized subtraction scheme. As explained above, the quantized subtraction allows the skipping of the motion estimation procedure for parts of the image that remain unchanged or almost unchanged from frame to frame.

As mentioned above, a preferred embodiment includes a post-processing stage, which allows the setting of intelligent quantization-levels to the macroblocks, according to their level of motion.

The quantized subtraction scheme, the motion estimation algorithm, and the scheme for quantization of motion estimated portions of a frame according to their level of motion may be integrated into a single encoder.

Motion estimation is preferably performed on a gray scale image, although it could be done with a full color bitmap.

Motion estimation is preferably done with 8×8 or 16×16 pixel macroblocks, although the skilled man will appreciate that any appropriate size block may be selected for given circumstances.

The scheme for quantization of the motion-estimated portions of a frame according to respective magnitudes of motion, may be integrated into other rate-control schemes to provide fine tuning of the quantization level. However, in order to be successful, the quantization scheme preferably requires a motion estimation scheme which does not find artificial motions between similar areas.

Reference is now made to FIG. 24, which is a simplified flow chart showing a search strategy of the kind described above. Bold lines indicate the principle path through the flow chart. In FIG. 24, a first stage S1 comprises insertion of a new frame, generally being a full resolution color frame. The frame is substituted for a grayscale equivalent in step S2. In step S3, the grayscale equivalent is downsampled to produce a low resolution frame (LRF).

In step S4, the LRF is searched, according to any of the search strategies described above in order to arrive at 8×8 pixel distinctive supermacroblocks. The step is looped through until no further supermacroblocks can be identified.

In the following stage S5, distinctiveness verification, as described above, is carried out, and in step S6 the current supermacroblock is associated with the equivalent block in the full resolution frame (FRF). In step S7, motion vectors are estimated and in step S8, a comparison is made between the motion as determined in the LRF and the high resolution frame initially inserted.

In step S9, a failed search threshold is used to determine fits of given macroblocks with the neighboring 4 macroblocks, and this is continued until no further fits can be found. In step S10 a paving strategy is used to estimate motion vectors based on the fits found in step S9. Paving is continued until all neighbors showing fits have been used up.

Steps S5 to S10 are repeated for all the distinctive supermacroblocks. When it is determined that there are no further distinctive supermacroblocks then the process moves to step S11, in which standard encoding, such as simple arithmetic encoding is carried out on regions for which no motion has been identified, referred to as the unpaved areas.

It is noted that schemes for spreading from the initial pivots to find neighbors may use techniques from cellular automata. Such techniques are summarized in Stephen Wolfram, A New Kind Of Science, Wolfram Media Inc. 2002, the contents of which are hereby incorporated by reference.

In a particularly preferred embodiment of the present embodiment, a scalable recursive version of the above procedure is used, and in this connection, reference is now made to FIGS. 25-29.

The search used in the scalable recursive embodiment is an improved “Game of Life” type search, and uses successively a low resolution frame (LRF) which has been down sampled by 4 and a full resolution frame (FRF). The search is equivalent to a search on 8 and 4 frames and a full resolution frame.

The Initial search is simple, N—preferably 11-33—ultra super macroblocks (USMB) are taken to use as the starting point, that is to say as Pivot Macroblocks, macroblocks that may be used for paving in full resolution). The USMB are preferably searched using an LRF frame which has been down sampled by 4, that is at 1/16 of the original size.

The USMBs themselves are 12×12 pixels (representing 48×48 pixels in the FRF, which are 9 16×16 macroblocks). The search area is ±12 horizontally and ±8 vertically (24×16 search window) in two pixel jumps (±2, 4, 6, 8, 10, 12 Horizontally and ±2, 4, 6, 8 vertically). The USMB includes 144 pixels, but in general, only a quarter of the pixels are matched during the search. The pattern (4-12) shown in FIG. 25, namely successive falling rows of four in the horizontal direction, is used to help the implementation, and the implementation may use various graphics acceleration systems such as MMX, 3D Now, SSE and DSP SAD acceleration: In the search, for each square block of 16 pixels, 4 pixels are matched and 12 are skipped. As shown in FIG. 25, starting from the top left hand side, a row of four is searched and then three rows are skipped, and so on down the first column. The search then moves on to the second column where a shift downwards occurs, in that the first row of four is ignored and the second row is searched. Subsequently every fourth row is searched as before. A similar shift is carried out for the third column. The matching carried out is a Down Sample by 8 Emulation.

The search allows for motion vectors to be set between matched portions of the initial and subsequent frames. Referring now to FIG. 26, when the new motion vectors are set, the USMB is divided into 4 SMBs in the same frame down sampled by 4 as follows:

4 6×6 SMBs are searched ±1 pixel for motion matching, and the best of each four is raised to full resolution, each SMB representing a full resolution 24×24 block of pixels.

At full resolution, the search pattern is similar to the down sample 4 (DS4) first pattern, with the exception that a 16×16 pixels MB (4-16) is used, as shown in FIG. 27. The block which is matched is the MB which was fully included within the 24×24 block represented by the best-of-four SMB. That is to say recognition is given to the best match.

At first, the MBs, which were contained within the 6×6 best-of-four SMBs are searched in full resolution within the range of ±6 pixels. All the results are sorted and an initial number of N starting points is set, to carry out initial global searching preferably in parallel.

There is a possibility of carrying out the search without use of any threshold whatsoever. In such a case there is no distinctiveness check of any kind. Each and every USMB ends up with a single full resolution MB! However a threshold can be advantageously used to determine distinctiveness, and lowering the threshold in the second round (cycle) allows continuance of paving of MBs that have not been paved during the first cycle.

A paving process preferably begins with the MB having the best, that is to saylowest, value in the set. The measure used for the value may be the L1 norm, L1 being the same as SAD mentioned above. Alternatively any other suitable measure may be used.

After the first paving (of four adjacent MBs to the first Pivot) the values are recorded in the set and resorted. Subsequent paving operations begin, in the same way, from the best MB in the set.

In an embodiment, full sorting may be avoided by inserting the MBs that are found into between 5 and 10 lists according to their respective L1 norm values, for example as follows:

50≧In≧40>H≧35>G≧30>F≧25>E≧20>D≧15>C≧10>B≧5>A≧0

Whenever a MB is matched it is removed from the set, preferably by marking it as matched.

The paving is carried out in three passes and is indicated in general by the flow chart of FIG. 29. The first pass continues until achievement of a first pass stopping condition. For example such a first pass stopping condition may be that there remain no MBs with a value equal to or smaller than 15 in the bank. Each MB may be searched within the range of ±1 pixel, and for higher quality results that range may be extended to ±4 pixels.

Once the first pass stopping condition occurs, namely in the above example that there are no more MBs with a value equal to or less than 15, a second pass is begun. In the second pass, a second set (N2) of USMB for which the L1 threshold value is now slightly increased to (10-15), is searched in the same manner as described above. The starting coordinates of the USMBs are chosen according to the coverage of the paving following the first pass. That is to say, in this second pass, only those USMBs, whose corresponding MBs, (9 for each USMB) have not yet been paved, are selected. A second criterion for selection of starting co-ordinates, is that no adjacent USMBs are selected. Thus, in a preferred embodiment, the method by which the starting coordinates of the second USMB set are selected, comprises using the following scheme:

Each paved MB (16×16) in the Full Resolution is associated with one or more 6×6 SMBs in DS4 (down sample by four or 1/16 resolution), As a result, these SMBs are excluded from the set of possible candidates for the second round search (N2). In practice, the association is conducted at the full resolution level by checking if the (paved) MB is partially included in one or more projections of the initial set of SMBs (from DS4) on the full resolution level.

Each 6×6 SMB in DS4 is projected onto a 24×24 block in the Full Resolution level. It is thus possible to define an association between an MB and an SMB if at least one of the vertices of the MB is strictly included in the projection of a given SMB. FIG. 28 depicts four distinct association possibilities in which the MB is projected in different ways around the surrounding SMBs. The possibilities are as follows:

a) the MB is associated with the lower left (24×24) block, since only one vertex of the MB is included,

b) the MB is associated with upper right and left blocks,

c) the MB is associated with the upper left block, and

d) the MB is associated with all four of the blocks.

Using the above described procedure, only still uncovered or unpaved SMB candidates are selected for a set referred to as N2. A further selection is then preferably applied to N2, in which only those SMBs that are completely isolated i.e. those that do not have common edges with other, are allowed to remain in N2.

A stopping condition is then preferably set for a second paving operation, namely that no MBs with an L1 value equal or smaller to 25 or 30 are left in the set.

A second paving operation is then carried out. When the stopping condition is reached, a third paving operation is begun using a 6×6 SMB in the LRF which is down sampled by 4. Again, 2 pixels skips are carried out (that is to say searching is restricted to evens only) and the same search range is used. Consequently it is possible to cover smaller starting areas, as with the 4-12 pattern of the previous 2 paving passes. The number of SMBs for the third search is up to 11. The SMBs are then matched again (according to the updated MVs) in Full Resolution (4-16 pattern) within the range of ±6 pixels.

The paving of the MBs continues using the best MB in the set each time, until the full frame is covered.

The number of paving operations is a variable that may be altered depending on the desired output quality. Thus the above described procedure in which paving is continued until the full frame is covered may be used for high quality, e.g. broadcast quality. The procedure may, however, be stopped at an earlier stage to give lower quality output in return for lower processing load.

Alternatively, the stopping conditions may be altered in order to give different balances between processing load and output quality.

Motion Estimation for B Frames

In the following, an application is described in which the above embodiment is applied to B-frame motion estimation.

B frames are bi-directionally interpolated frames in a sequence of frames that is part of the video stream.

B frame Motion Estimation is based on the paving strategy discussed above in the following manner:

A distinction may be made between two kinds of motion estimation:

1. Global motion estimation: Estimating motion from I to P or P to P frames, and

2. Local motion estimation: Estimating motion from I to B or B to P frames.

A particular benefit of using the above-described paving method for B frame motion estimation is that one is able to trace macroblocks between non-adjacent frames, in contrast with conventional methods that perform their searches on each individual macroblock as it moves over two adjacent frames.

The distance (i.e. differences as represented statistically) between frame pairs in Global motion estimation is obviously greater then frame pairs in Local motion estimation, since the frames are further apart temporally.

By way of example, in the following sequence:

I B B P B B P B B P B B P

Global motion estimation is used for frame pairs I,P and P,P that are located 3 frames apart, white local motion estimation is used for frame pairs I,B and B,P that are located 1 or 2 frames apart. The increased difference level entails using a more rigorous effort when carrying out Global motion estimation than Local motion estimation. By contrast, Local motion estimation could exploit Global motion estimation results, for example to provide as a starting point.

A procedure is now outlined for carrying out Local ME for B frames. The procedure comprises four stages, as described below and uses results that have been obtained from Global motion estimation to provide a starting point:

Stage 1:

In accordance with the above embodiments, initial paving pivot macroblocks are found using either of the following two methods:

a)—Selecting the macro-blocks that were used as an initial set for the I->P paving in the preceding global motion estimation, or

b) Selecting evenly distributed macroblocks having the best SAD values from the already paved macroblocks from the I->P frame pair.

For example, given two B frames in the “I B1 B2 P” sequence, motion estimation may be performed for the following frame pairs:

I->B1, I->B2, and

B1->P, B2->P.

The motion estimation is carried out using paving around the initial paving pivots, and the motion vectors for the paving pivots are interpolated from the motion vectors of the I->P frames' macro-blocks using the following formulas (The interpolation is given for an IBBP sequence, it can be easily modified for different sequences):

Given a macroblock whose I->P motion vectors are {x,y}, the interpolated motion vectors for:

I->B1: {x1,y1}={⅓x, ⅓y}

I->B2: {x2,y2}={⅔x, ⅔y}

B1->P: {x3,y3}={−⅔x, −⅔y}

B2->P: {x4,y4}={−⅓x, −⅓y}

The interpolated motion vectors are further refined using a direct search in the range of ±2 pixels.

Stage 2:

The paving pivots are now preferably added to a data set S, sorted in accord with the SAD (or L1 norm) values.

At every step, the unpaved neighbors of the source MB whose SAD is the lowest in S are determined.

In the process, each neighbor in a range of ±N around the motion vectors of it's source MB is searched.

The matching threshold is set at this point to a value T1. For example 15 per pixel.

If the resulting SAID is lower then the threshold, then the MB is marked as paved and added into set S, which set is discussed above.

The procedure is continued until S has been exhaustively searched and there are no more pivot MBs to search, which is to say that the whole frame is paved or all the neighbours of the pivots are matched or found to be non-matching.

Stage 3:

If unpaved areas of macro-blocks remain in the frame, then a second set of pivot macro-blocks are obtained inside the remaining unpaved holes.

The pivot macroblocks are preferably selected in accordance with the following conditions:

a) any two pairs of macro-blocks may not have a common edge, and

b) the total number of macro-blocks is preferably limited to a predefined relatively small number N2.

A search is now performed over a range of N pixels around the interpolated motion vector values as described above.

Macro-blocks are preferably added to the data set S and sorted, as in stage 2 above.

Paving is performed, as in stage 2 above. The paving SAD threshold is increased to a new value T2, as explained above.

The procedure is continued until S has been exhaustively searched.

Stage 3 above is repeated as long as the number of unpaved macro-blocks exceeds N percent. The matching threshold is now increased to infinity.

Macro-blocks that are left unpaved after all of the above have been completed may be searched using any standard methods such as a 4 step search, or may be left as they are for arithmetic encoding.

Stage 4:

Once the paving in the previous stages has been completed, for every B frames there are now two paved reference frames.

For every macroblock in B, a choice is made between the following, in accordance with the MPEG standard:

1. Replacing the macro-block with its corresponding macro-block from frame I,

2. Replacing the macro-block with its corresponding macro-block from frame P,

3. Replacing the macro-block with the average of its corresponding macro-blocks from frame I and P, and

4. Not replacing the macro-block.

The decision as to which of the above options 1 to 4 to choose preferably depends on the variance of the match value, that is to say the value achieved by the matching criteria, for example the SEM metric. L1 metric etc on which the initial matching was based.

The final embodiment thus provides a way of providing motion vectors that is scalable according to the final picture quality required and the processing resources available.

It is noted that the search is based on pivot points located in the frame. The complexity of the search does not increase with the size of the frame as with the typical prior art exhaustive searches. Typically a reasonable result for a frame can be achieved with a mere four initial pivot points. Also, since multiple pivot points are used, a given pixel can be rejected as a neighbor by searching from one pivot point but may nevertheless be detected as a neighbor by searching from another pivot point and approaching from a different direction.

It is appreciated that features described only in respect of one or some of the embodiments are applicable to other embodiments and that for reasons of space it is not possible to detail all possible combinations. Nevertheless, the scope of the above description extends to all reasonable combinations of the above described features.

The present invention is not limited by the above-described embodiments, which are given by way of example only. Rather the invention is defined by the appended claims.

We claim:

1. Apparatus for determining motion in video frames, the apparatus comprising:
a motion estimator for tracking a feature between a first one of said video frames and in a second one of said video frames, therefrom to determine a motion vector of said feature, and
a neighboring feature motion assignor, associated with said motion estimator, for applying said motion vector to other features neighboring said first feature and appearing to move with said first feature.

2. The apparatus of claim 1, wherein said tracking a feature comprises matching blocks of pixels of said first and said second frames.

3. The apparatus of claim 2, wherein said motion estimator is operable to select initially a predetermined small groups of pixels in a first frame and to trace said groups of pixels in said second frame to determine motion therebetween, and wherein said neighboring feature motion assignor is operable, for each group of pixels, to identify neighboring groups of pixels that move therewith.

4. The apparatus of claim 3, wherein said neighboring feature assignor is operable to use cellular automata based techniques to find said neighboring groups of pixels to identify, and assign motion vectors to these groups of pixels.

5. The apparatus of claim 3, further operable to mark all groups of pixels assigned a motion as paved, and to repeat said motion estimation for unmarked groups of pixels by selecting further groups of pixels to trace and find neighbors therefor, said repetition being repeated up to a predetermined limit.

6. Apparatus according to claim 1, further comprising a feature significance estimator, associated with said neighboring feature motion assignor, for estimating a significance level of said feature, thereby to control said neighboring feature motion assignor to apply said motion vector to said neighboring features only if said significance exceeds a predetermined threshold level.

7. The apparatus of claim 6, further operable to mark all groups of pixels in a frame assigned a motion as paved, said marking being repeated up to a predetermined limit according to a threshold level of matching, and to repeat said motion estimation for unpaved groups of pixels by selecting further groups of pixels to trace and find unmarked neighbors therefor, said predetermined threshold level being kept or reduced for each repetition.

8. Apparatus according to claim 6, said feature significance estimator comprising a match ratio determiner for determining a ratio between a best match of said feature in said succeeding frames and an average match level of said feature over a search window, thereby to exclude features indistinct from a background or neighborhood.

9. Apparatus according to claim 6, wherein said feature significance estimator comprises a numerical approximator for approximating a Hessian matrix of a misfit function at a location of said matching, thereby to determine the presence of a maximal distinctiveness.

10. Apparatus according to claim 6, wherein, said feature significance estimator is connected prior to said feature identifier and comprises an edge detector for carrying out an edge detection transformation, said feature identifier being controllable by said feature significance estimator to restrict feature identification to features having relatively higher edge detection energy.

11. Apparatus according to claim 1, further comprising a downsampler connected before said feature identifier for producing a reduction in video frame resolution by merging of pixels within said frames.

12. Apparatus according to claim 1, further comprising a downsampler connected before said feature identifier for isolating a luminance signal and producing a luminance only video frame.

13. Apparatus according to claim 12, wherein said downsampler is further operable to reduce resolution in said luminance signal.

14. Apparatus according to claim 1, wherein said succeeding frames are successive frames.

15. Apparatus according to claim 14, wherein said frames are a sequence of an I frame, a B frame and a P frame, wherein motion estimation is carried out between said I frame and said P frame and wherein the apparatus further comprises an interpolator for providing an interpolation of said motion estimation to use as a motion estimation for said B frame.

16. Apparatus according to claim 14, wherein said frames are a sequence comprising at least an I frame, a first P frame and a second P frame, wherein motion estimation is carried out between said I frame and said first P frame and wherein the apparatus further comprises an extrapolator for providing an extrapolation of said motion estimation to use as a motion estimation for said second P frame.

17. Apparatus according to claim 1, wherein said frames are divided into blocks and wherein said feature identifier is operable to make a systematic selection of blocks within said first frame to identify features therein.

18. Apparatus according to claim 1, wherein said frames are divided into blocks and wherein said feature identifier is operable to make a random selection of blocks within said first frame to identify features therein.

19. Apparatus according to claim 1, said motion estimator comprising a searcher for searching for said feature in said succeeding frame in a search window around the location of said feature in said first frame.

20. Apparatus according to claim 19, further comprising a search window size presetter for presetting a size of said search window.

21. Apparatus according to claim 19, wherein said frames are divided into blocks and said searcher comprises a comparator for carrying out a comparison between a block containing said feature and blocks in said search window, thereby to identify said feature in said succeeding frame and to determine a motion vector of said feature between said first frame and said succeeding frame, for association with each of said blocks.

22. Apparatus according to claim 21, wherein said comparison is a semblance distance comparison.

23. Apparatus according to claim 22, further comprising a DC corrector for subtracting average luminance values from each block prior to said comparison.

24. Apparatus according to claim 21, wherein said comparison comprises non-linear optimization.

25. Apparatus according to claim 24, wherein said non-linear optimization comprises the Nelder Mead Simplex technique.

26. Apparatus according to claim 21, wherein said comparison comprises use of at least one of L1 and L2 norms.

27. Apparatus according to claim 21, further comprising a feature significance estimator for determining whether said feature is a significant feature.

28. Apparatus according to claim 27, wherein said feature significance estimator comprises a match ratio determiner for determining a ratio between a closest match of said feature in said succeeding frames and an average match level of said feature over a search window, thereby to exclude features indistinct from a background or neighborhood.

29. Apparatus according to claim 28, wherein said feature significance estimator further comprises a thresholder for comparing said ratio against a predetermined threshold to determine whether said feature is a significant feature.

30. Apparatus according to claim 27, wherein said feature significance estimator comprises a numerical approximator for approximating a Hessian matrix of a misfit function at a location of said matching, thereby to locate a maximum distinctiveness.

31. Apparatus according to claim 27, wherein said feature significance estimator is connected prior to said feature identifier, the apparatus further comprising an edge detector for carrying out an edge detection transformation, said feature identifier being controllable by said feature significance estimator to restrict feature identification to regions of detection of relatively higher edge detection energy.

32. Apparatus according to claim 27, wherein said neighboring feature motion assignor is operable to apply said motion vector to each higher resolution block of said frame corresponding to a low resolution block for which said motion vector has been determined.

33. Apparatus according to claim 27, wherein said neighboring feature motion assignor is operable to apply said motion vector to each full resolution block of said frame corresponding to a low resolution block for which said motion vector has been determined.

34. Apparatus according to claim 32, comprising a motion vector refiner operable to carry out feature matching on high resolution versions of said succeeding frames to refine said motion vector at each of said higher resolution blocks.

35. Apparatus according to claim 33, comprising a motion vector refiner operable to carry out feature matching on high resolution versions of said succeeding frames to refine said motion vector at each of said full resolution blocks.

36. Apparatus according to claim 34, wherein said motion vector refiner is further operable to carry out additional feature matching operations on adjacent blocks of feature matched higher resolution blocks, thereby further to refine said corresponding motion vectors.

37. Apparatus according to claim 35, wherein said motion vector refiner is further operable to carry out additional feature matching operations on adjacent blocks of feature matched full resolution blocks, thereby further to refine said corresponding motion vectors.

38. Apparatus according to claim 36, wherein said motion vector refiner is further operable to identify higher resolution blocks having a different motion vector assigned thereto from a previous feature matching operation originating from a different matched block, and to assign to any such higher resolution block an average of said previously assigned motion vector and a currently assigned motion vector.

39. Apparatus according to claim 37, wherein said motion vector refiner is further operable to identify full resolution blocks having a different motion vector assigned thereto from a previous feature matching operation originating from a different matched block, and to assign to any such full resolution block an average of said previously assigned motion vector and a currently assigned motion vector.

40. Apparatus according to claim 36, wherein said motion vector refiner is further operable to identify higher resolution blocks having a different motion vector assigned thereto from a previous feature matching operation originating from a different matched block, and to assign to any such higher resolution block a rule decided derivation of said previously assigned motion vector and a currently assigned motion vector.

41. Apparatus according to claim 37, wherein said motion vector refiner is further operable to identify full resolution blocks having a different motion vector assigned thereto from a previous feature matching operation originating from a different matched block, aid to assign to any such full resolution block a rule decided derivation of said previously assigned motion vector and a currently assigned motion vector.

42. Apparatus according to claim 36, further comprising a block quantization level assigner for assigning to each high resolution block a quantization level in accordance with a respective motion vector of said block.

43. Apparatus according to claim 1, wherein said frames are arrangeable in blocks, the apparatus further comprising a subtractor connected in advance of said feature detector, the subtractor comprising:
a pixel subtractor for pixelwise subtraction of luminance levels of corresponding pixels in said succeeding frames to give a pixel difference level for each pixel, and
a block subtractor for removing from motion estimation consideration any block having an overall pixel difference level below a predetermined threshold.

44. The apparatus of claim 1, wherein said feature identifier is operable to search for features by examining said frame in blocks.

45. The apparatus of claim 44, wherein said blocks are of a size in pixels according to at least one of the MPEG and JVT standard.

46. The apparatus of claim 45, wherein said blocks are any one of a group of sizes comprising 8×8, 16×8, 8×16 and 16×16.

47. The apparatus of claim 44, wherein said blocks are of a size in pixels lower than 8×8.

48. The apparatus of claim 47, wherein said blocks are of size no larger than 7×6 pixels.

49. The apparatus of claim 47, wherein said blocks are of size no larger than 6×6 pixels.

50. The apparatus of claim 1, wherein said motion estimator and said neighboring feature motion assigner are operable with a resolution level changer to search and assign on successively increasing resolutions of each frame.

51. The apparatus of claim 50, wherein said successively increasing resolutions are respectively substantially at least some of a 1/64, 1/32, 1/16, eighth, a quarter, a half and full resolution.

52. Apparatus for video motion estimation comprising:
a non-exhaustive search unit for carrying out a non exhaustive search between low resolution versions of a first video frame and a second video frame respectively, said non-exhaustive search being to find at least one feature persisting over said frames, and to determine a relative motion of said feature between said frames.

53. The apparatus of claim 52, wherein said non-exhaustive search unit is further operable to repeat said searches at successively increasing resolution versions of said video frames.

54. The apparatus of claim 52, further comprising a neighbor feature identifier for identifying a neighbor feature of said persisting feature that appears to move with said persisting feature, and for applying said relative motion of said persisting feature to said neighbor feature.

55. The apparatus of claim 52, further comprising a feature motion quality estimator for comparing matches between said persisting feature in respective frames with an average of matches between said persisting feature in said first frame and points in a window in said second frame, thereby to provide a quantity expressing a goodness of said match to support a decision as to whether to use said feature and corresponding relative motion in said motion estimation or to reject said feature.

56. A video frame subtractor for preprocessing video frames arranged in blocks of pixels for motion estimation, the subtractor comprising:
a pixel subtractor for pixelwise subtraction of luminance levels of corresponding pixels in succeeding frames of a video sequence to give a pixel difference level for each pixel, and
a block subtractor for removing from motion estimation consideration any block having an overall pixel difference level below a predetermined threshold.

57. A video frame subtractor according to claim 56, wherein said overall pixel difference level is a highest pixel difference value over said block.

58. A video frame subtractor according to claim 56, wherein said overall pixel difference level is a summation of pixel difference levels over said block.

59. A video frame subtractor according to claim 57, wherein said predetermined threshold is substantially zero.

60. A video frame subtractor according to claim 58, wherein said predetermined threshold is substantially zero.

61. A video frame subtractor according to claim 56, wherein said predetermined threshold of said macroblocks is substantially a quantization level for motion estimation.

62. A post-motion estimation video quantizer for providing quantization levels to video frames arranged in blocks, each block being associated with motion data, the quantizer comprising a quantization coefficient assigner for selecting, for each block, a quantization coefficient for setting a detail level within said block, said selection being dependent on said associated motion data.

63. Method for determining motion in video frames arranged into blocks, the method comprising:
matching a feature in succeeding frames of a video sequence,
determining relative motion between said feature in a first one of said video frames and in a second one of said video frames, and
applying said determined relative motion to blocks neighboring said block containing said feature that appear to move with said feature.

64. The method of claim 63, further comprising determining whether said feature is a significant feature.

65. The method of claim 64, wherein said determining whether said feature is a significant feature comprises determining a ratio between a closest match of said feature in said succeeding frames and an average match level of said feature over a search window.

66. The method of claim 65, further comprising comparing said ratio against a predetermined threshold, thereby to determine whether said feature is a significant feature.

67. The method of claim 64, comprising approximating a Hessian matrix of a misfit function at a location of said matching, thereby to produce a level of distinctiveness.

68. The method of claim 64, comprising carrying out an, edge detection transformation, and restricting feature identification to blocks having higher edge detection energy.

69. The method of claim 63, further comprising producing a reduction in video frame resolution by merging blocks in said frames.

70. The method of claim 63, further comprising isolating a luminance signal, thereby to produce a luminance only video frame.

71. The method of claim 70, further comprising reducing resolution in said luminance signal.

72. The method of claim 63, wherein said succeeding frames are successive frames.

73. The method of claim 63, further comprising making a systematic selection of blocks within said first frame to identify features therein.

74. The method of claim 63, further comprising making a random selection of blocks within said first frame to identify features therein.

75. The method of claim 63, further comprising searching for said feature in blocks in said succeeding frame in a search window around the location of said feature in said first frame.

76. The method of claim 75, further comprising presetting a size of said search window.

77. The method of claim 75, further comprising carrying out a comparison between said block containing said feature and said blocks in said search window, thereby to identify said feature in said succeeding frame and determine a motion vector for said feature, to be associated with said block.

78. The method of claim 77, wherein said comparison is a semblance distance comparison.

79. The method of claim 78, further comprising subtracting average luminance values from each block prior to said comparison.

80. The method of claim 77, wherein said comparison comprises non-linear optimization.

81. The method of claim 80, wherein said non-linear optimization comprises the Nelder Mead Simplex technique.

82. The method of claim 77, wherein said comparison comprises use of at least one of a group comprising L1 and L2 norms.

83. The method of claim 77, further comprising determining whether said feature is a significant feature.

84. The method of claim 83, wherein said feature significance determination comprises determining a ratio between a closest match of said feature in said succeeding frames and an average match level of said feature over a search window.

85. The method of claim 84, further comprising comparing said ratio against a predetermined threshold to determine whether said feature is a significant feature.

86. The method of claim 83, further comprising approximating a Hessian matrix of a misfit function at a location of said matching, thereby to produce a level of distinctiveness.

87. The method of claim 83, comprising carrying out an edge detection transformation, and restricting feature identification to regions of higher edge detection energy.

88. The method of claim 83, further comprising applying said motion vector to each high resolution block of said frame corresponding to a low resolution block for which said motion vector has been determined.

89. The method of claim 88, comprising carrying out feature matching on high resolution versions of said succeeding frames to refine said motion vector at each of said high resolution blocks.

90. The method of claim 89, further comprising carrying out additional feature matching operations on adjacent blocks of feature matched high resolution blocks, thereby further to refine said corresponding motion vectors.

91. The method of claim 90, further comprising identifying high resolution blocks having a different motion vector assigned thereto from a previous feature matching operation originating from a different matched block, and assigning to any such high resolution block an average of said previously assigned motion vector and a currently assigned motion vector.

92. The method of claim 90, further comprising identifying high resolution blocks having a different motion vector assigned thereto from a previous feature matching operation originating from a different matched block, and assigning to any such high resolution block a rule decided derivation of said previously assigned motion vector and a currently assigned motion vector.

93. The method of claim 90, further comprising assigning to each high resolution block a quantization level in accordance with a respective motion vector of said block.

94. The method of claim 63, further comprising
pixelwise subtraction of luminance levels of corresponding pixels in said succeeding frames to give a pixel difference level for each pixel, and
removing from motion estimation consideration any block having an overall pixel difference level below a predetermined threshold.

95. A video frame subtraction method for preprocessing video frames arranged in blocks of pixels for motion estimation, the method comprising:
pixelwise subtraction of luminance levels of corresponding pixels in succeeding frames of a video sequence to give a pixel difference level for each pixel, and
removing from motion estimation consideration any block having an overall pixel difference level below a predetermined threshold.

96. The method of claim 95, wherein said overall pixel difference level is a highest pixel difference value over said block.

97. The method of claim 95, wherein said overall pixel difference level is a summation of pixel difference levels over said block.

98. The method of claim 96, wherein said predetermined threshold is substantially zero.

99. The method of claim 97, wherein said predetermined threshold is substantially zero.

100. The method of claim 95, wherein said predetermined threshold of said macroblocks is substantially a quantization level for motion estimation.

101. A post-motion estimation video quantization method for providing quantization levels to videoframes arranged in blocks, each block being associated with motion data, the method comprising selecting, for each block, a quantization coefficient for setting a detail level within said block, said selection being dependent on said associated motion data.
